(19) United States
(12) Patent Application Publication
(10) Pub. No.: US 2005/0279908 A1
(43) Pub. Date: Dec. 22, 2005

(54) Wall hanger positioner

(76) Inventor: Emad El Haje, Washington, DC (US)

Correspondence Address: Barnes & Thornburg, Suite 900, 750 17th Street, NW, Washington, DC, 20006, US

(21) Appl. No.: 10/872,678

(22) Filed: Jun. 22, 2004

(51) Int. Cl. B60R 1/02; A47G 1/24

(52) U.S. Cl. 248/476

(57) ABSTRACT

A hanger positioner for mounting objects to wall comprises a telescopic device wherein each of the telescopic members has a protuberance that can fit into hanger openings on the object to be mounted by the sliding of one telescopic member relative to another and wherein a wall marking device is located in alignment with each protuberance so that after the telescopic members are properly aligned to the hanger openings the positioner can be placed against a wall so that the wall marking devices can make a mark on the wall in alignment with hanger openings.

### BACKGROUND AND SUMMARY OF THE INVENTION

When hanging objects (such as objects de arte, shelving, cabinets, etc.) on building walls when the objects are provided with plural hanging openings, the distance between the hanger openings on the objects needs to be determined in order that wall fixation devices for the object are properly located. Where the hanger openings are not accessible from the front of the object calculating the distance between then is not always easy. The invention herein provides for a wall hanger positioning device which is provided with wall markers that can be easily aligned with the hanger openings on the object and can be placed against a wall to clearly locate the places for fixation devices.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a schematic 3-dimensional view of the rear side of an object to be mounted on a building wall;

FIG. 2 shows a 3-dimensional front view of a hanger positioner used to measure the distance between the hanger openings of an object to be mounted on a building wall;

FIG. 3 is a side view of the hanger positioner of FIG. 2 showing one embodiment of a protuberance marker of the hanger positioner of FIG. 2;

FIG. 4 is a side view of the hanger positioner of FIG. 2, showing a second embodiment for a protuberance marker of the hanger positioner of FIG. 2;

FIG. 5 is a 3-dimensional front view of the hanger positioner of FIG. 2 when provided with a third telescoping member;

FIG. 6 is a 3-dimensional front view of the hanger positioner of FIG. 5 when provided with a fourth telescopic member;

FIG. 7 is a side view of the hanger positioner of FIG. 2 showing use of a common nail as the protuberance marker of FIG. 2. A level indicator is also shown;

FIG. 8 is a 3-dimensional front view of the hanger positioner of FIG. 2 showing wall mounts for the hanger positioner; and

FIG. 9 shows a modified cross-section for the hanger positioner of FIG. 2;

### DETAILED DESCRIPTION OF THE DRAWINGS

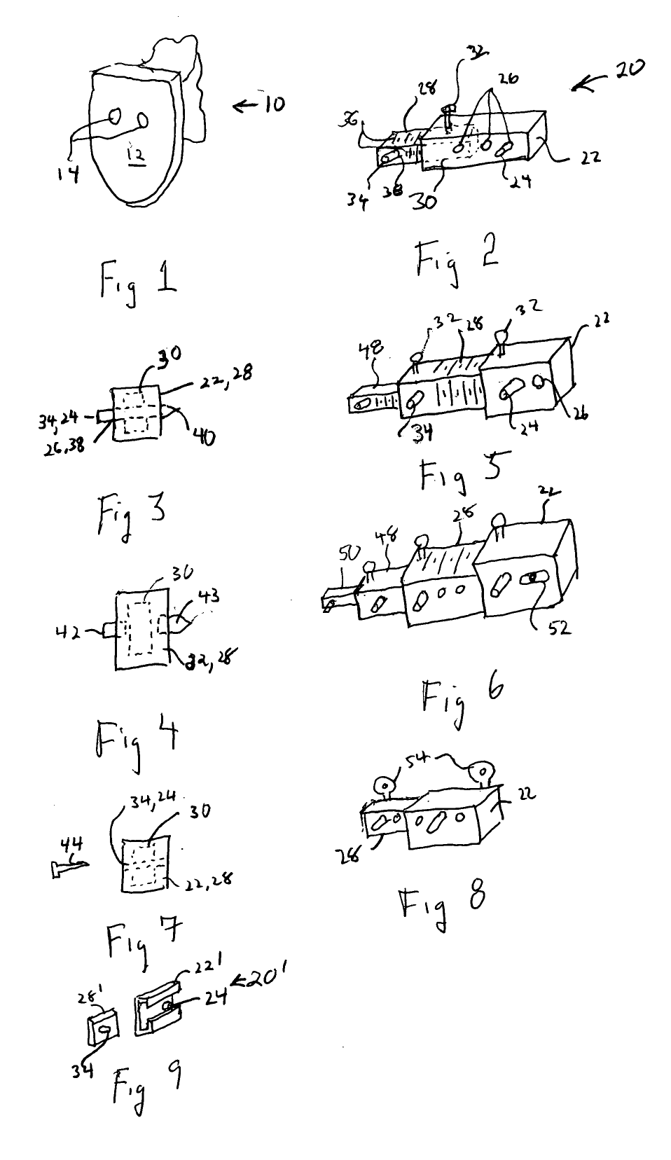

FIG. 1 shows the rear side of an object de arte 10 mounted on a backing plate 12 providing with hanger openings 14 for receiving wall hangers (not shown) for the mounting of the object de arte 10 to a wall of a building. The wall hangers need to be positioned exactly on the wall so that they will align with hanger openings 14. Since the hanger openings 14 cannot be viewed from the front of the object de arte 10, the object de arte 10 cannot be placed against a wall to permit tracing of the location of the openings 14 on the wall. Additionally, since the openings 14 are sometimes round or are keyhole configuration, use of a ruler to locate the distance between the centers thereof can be difficult.

FIG. 2 shows a hanger positioner 20 having a first body part 22 with a first protuberance member 24 located in the right most bore 26 formed in the first body 22. The protuberance member can be located in any one of the bores 26. The number of bores shown is three, but there can be one or more as desired. The number of bores 26 offers an adjustment feature for measuring long and short distances. A second body part 28 is movably and telescopically received in a bore 30 in the first body party 22 and can be locked in position relative to the first body part by screw 32 that extends from a top side of the body part into the bore 30 to contact a edge of the second body part 28. The second body part has a second protuberance member 34 located in a bore 38 extending therein similarly as protuberance 24. While only one bore 38 is shown, the second body member can be provided with a plurality of bores 38. The second body member is also provided with a scale indicia 36 (on one or all sides) to indicate the distance between the two protuberances 24 and 34.

In use the screw 32 is loosened to allow relative movement between the two body parts 28 and 22 and the positioner 20 is placed against the back side of the backing plate twelve and the body parts 22 and 25 are telescoped to the point that the two protuberances 24 and 34 can fit into the openings 14 of the back plate 12. The screw 32 is then tightened and the locations of the protuberances 24 and 34 on the positioner 20 replicates the location of the openings 14.

The protuberance 24, 34 can extend completely through a body part 22, 28 as shown in FIG. 3 and can have a pointed end 40 which can be placed against a wall and pushed into the wall to locate the position on a wall where a user is to locate a hanger fixation for the object 10. As shown in FIG. 3 the protuberance is shown as a rigid member with a point 40 (such as a nail) and it could be replaced with a pencil that extends through the bores 26, 38 to make a pencil notation on the wall.

When the positioner 20 has its protuberances 24, 34 inserted into bores 14, the object 10 with the positioner 10 attached can be placed against a wall at the proper height and pushed against the wall to have the point 40 make a proper impression or mark (in the case of a pencil) on the wall. Under such use, a user need not use or have the screw 32 to lock the two body portions 22, 28 together. Alternatively, when the protuberances 34, 24 are properly aligned and locked together by screw 32, only the positioner 20 need be placed against the wall to mark the location for the hangers.

FIG. 4 shows a modification of the protuberances 24, 34 wherein they are formed in two parts 42, 43. Under such a construction, the bores 26, 38 need not go completely through the body parts 22, 28.

FIG. 7 shows a modification where a protuberance 34, 24, part 42 is removed after alignment and locking by screw 32, then the positioner 20 is placed against a wall and a nail 44 is inserted into the bore to mark the place on a wall for the hanger.

FIG. 5 shows a modified positioner 20 which has three body parts 22, 28, 48. This is especially adapted for objects 10 having three mounting openings 14. FIG. 7 shows a modified positioner 20 which has four body parts 22, 28, 48 and 50. This allows a user to place two objects on a wall with proper spacing between them. FIG. 6 also shows a bubble level 52 which can be used to properly align the markings on a wall to be horizontal. While the level 52 is shown located on the first body part 22, it can be located on any or all body parts 22, 28, 48 and 40.

FIG. 8 shows a modification of the positioner 20 wherein hangers 54 are attached to the positioner 42 (FIG. 4) as needed. Once the two body parts 22, 28 are adjusted and locked by the screw 32, the positioner can be the hanger after it is mounted to the wall through hangers 54.

FIG. 9 shows a modification of the body parts 22, 28, 48, and 50 of the positioner 20 wherein the first body part 22 is shown to have a generally C-shaped cross-section and the second body part 28 has a thin flat rectangular cross-section. This configuration could be easily manufactured in cardboard or plastic. Further, the four body part construction of FIG. 6 could easily be obtained by putting two of the modified positions 20 together in a series. Here too the lock screw 32, level 52 and or hanger 54 features could be used. If the body parts are tightly fitted together or have a roughened surface, the locks 32 can be eliminated since friction can hold the body parts at a desired adjustment.

Although the present invention has been described and illustrated in detail, it is to be clearly understood that the same is by way of illustration and example only, and is not to be taken by way of limitation. The spirit and scope of the present invention are to be limited only by the terms of the appended claims.

1. A hanger positioner comprising:
a first body part;
a second body part;
the second body part connected to the first body part to be linearly moveable with respect thereto;
a first protuberance member on the first body part and provided with an extended end;
a second protuberance member on the second body part and provided with an extended end;
a first wall marker associated with the extended end of the first protuberance member for marking a building wall surface to indicate the location of the extended end of the first protuberance member; and
a second wall marker associated with the extended end of the second protuberance for marking a building wall surface to indicate the location of the extended end of the second protuberance member.

2. The hanger positioner of claim 1 wherein the connection between the first and second body parts is telescopic with one of the first and second body part inserted into a passageway in another of the first and second body parts.

3. The hanger positioner of claim 1 wherein at least one of the first and second body parts has a plurality of bores and wherein at least one of the first and second protuberance members can be partially inserted into any one of the plurality of bores.

4. The hanger positioner of claim 2 wherein at least one of the first and second body parts has a plurality of bores and wherein at least one of the first and second protuberance members can be partially inserted into any one of the plurality of bores.

5. The hanger positioner of claim 1 wherein at least one of the wall markers is physically attached to at least one of the protuberance members.

6. The hanger positioner of claim 2 wherein at least one of the wall markers is physically attached to at least one of the protuberance members.

7. The hanger positioner of claim 3 wherein at least one of the wall markers is physically attached to at least one of the protuberance members.

8. The hanger positioner of claim 4 wherein at least one of the wall markers is physically attached to at least one of the protuberance members.

9. The hanger positioner of claim 5 wherein the at least one wall marker physically connected to the at least one of the protuberances is configured as at least one of a pencil and nail.

10. The hanger positioner of claim 6 wherein the at least one wall marker physically connected to the at least one of the protuberances is configured as at least one of a pencil and nail.

11. The hanger positioner of claim 7 wherein the at least one wall marker physically connected to the at least one of the protuberances is configured as at least one of a pencil and nail.

12. The hanger positioner of claim 8 wherein the at least one wall marker physically connected to the at least one of the protuberances is configured as at least one of a pencil and nail.

13. The hanger positioner of claim 1 wherein at least one of the first and second wall markers is configured as at least one of a pencil and nail.

14. The hanger positioner of claim 2 wherein at least one of the first and second wall markers is configured as at least one of a pencil and nail.

15. The hanger positioner of claim 3 wherein at least one of the first and second wall markers is configured as at least one of a pencil and nail.

16. The hanger positioner of claim 4 wherein at least one of the first and second wall markers is configured as at least one of a pencil and nail.

17. The hanger positioner of claim 1 wherein there is a third and fourth body part, wherein the third body part is connected to the second body part to be linearly moveable with respect thereto, and wherein the fourth body part is connected to the third body part to be linearly moveable with respect thereto.

18. The hanger positioner of claim 2 wherein there is a third and fourth body part, wherein the third body part is connected to the second body part to be linearly moveable with respect thereto, and wherein the fourth body part is connected to the third body part to be linearly moveable with respect thereto.

19. The hanger positioner of claim 3 wherein there is a third and fourth body part, wherein the third body part is connected to the second body part to be linearly moveable with respect thereto, and wherein the fourth body part is connected to the third body part to be linearly moveable with respect thereto.

20. The hanger positioner of claim 4 wherein there is a third and fourth body part, wherein the third body part is connected to the second body part to be linearly moveable with respect thereto, and wherein the fourth body part is connected to the third body part to be linearly moveable with respect thereto.

21. The hanger positioner of claim 1 wherein at least one of the body parts is provided with a level indicator to assist a user to orient the at least one body part horizontally.

22. The hanger positioner of claim 2 wherein the body part telescopically insertable into the other body part is provided with indicia partially covered by the other body which indicia indicates the distance between the first and second protuberance members.

23. The hanger positioner of claim 1 wherein the first body part is provided with wall mounts for mounting of the first body part to a building wall.

24. The hanger positioner of claim 1 wherein the first body part has a general C-shaped cross-section.

25. The hanger positioner of claim 2 wherein the first body part has a general C-shaped cross-section.
